(19) United States
(12) Patent Application Publication
(10) Pub. No.: US 2014/0181993 A1
(43) Pub. Date: Jun. 26, 2014

(54) Storage Device and Method for Using a Common Digital Rights Management Module to Enforce an Association between Content and a User Interface Application

(71) Applicants: Fabrice E. Jogand-Coulomb, Allauh (FR); Aran Ziv, Foster City, CA (US)

(72) Inventors: Fabrice E. Jogand-Coulomb, Allauh (FR); Aran Ziv, Foster City, CA (US)

(21) Appl. No.: 13/735,777

(22) Filed: Jan. 7, 2013

Related U.S. Application Data
(60) Provisional application No. 61/745,192, filed on Dec. 21, 2012.
(60) Provisional application No. 61/745,222, filed on Dec. 21, 2012.

(51) Int. Cl. G06F 21/60

(52) U.S. Cl. CPC G06F 21/60
USPC 726/27

(57) ABSTRACT

A storage device, host device, and method are provided for using a common digital rights management (DRM) module to enforce an association between content and a user interface application. In one embodiment, a storage device is provided with a DRM module that receives a request from a user interface application to play back content protected by DRM. The DRM module determines if the user interface application is authorized to play back the content and also if rights associated with the content are valid. If the DRM module determines both that the user interface application is authorized to play back the content and that the rights associated with the content are valid, the DRM module provides the content to a playback module for playback. In another embodiment, the DRM module is located in the host device. Other embodiments are possible, and each can be used alone or in combination.

### CROSS-REFERENCE TO RELATED APPLICATIONS

This application claims the benefit of U.S. Provisional Application Nos. 61/745,192 and 61/745,222, both of which were filed on Dec. 21, 2012 and are hereby incorporated by reference.

### BACKGROUND

Several mobile content services are available that allow a user to enjoy content on a mobile device, such as a cell phone. While content can be streamed to the device, network bandwidth limitations, as well as the user's data plan, may make streaming certain content undesirable. Accordingly, a user may want to download the content to his device for later consumption. When content is stored locally on a user's device, the content may contain digital rights management (DRM) protection to place limits on when and how the content can be consumed. In some environments, the device has a single DRM module that enforces these rights, and the single DRM module is shared by a plurality of user interface applications on the device. As such, any compatible user interface application on the device can request the DRM module to validate the DRM rights for any of the content stored on the device. So, as long as the DRM rights are valid, any user interface application on the device can play the content. Recently, there has been a desire to shift to a different model, in which only certain user interface applications can play certain content. To do this, instead of having one common DRM module servicing a number of user interface applications, each user interface application would have its own embedded DRM module. In this way, various pieces of content can be bound to specific user interface applications. This may be desired by a service provider in order to establish a direct relationship with the end user and develop additional revenue streams.

### OVERVIEW

Embodiments of the present invention are defined by the claims, and nothing in this section should be taken as a limitation on those claims.

By way of introduction, the below embodiments relate to a storage device, host device, and method for using a common digital rights management module to enforce an association between content and a user interface application. In one embodiment, a storage device is provided with a digital rights management (DRM) module that receives a request from a user interface application to play back content protected by DRM. The DRM module determines if the user interface application is authorized to play back the content and also if rights associated with the content are valid. If the DRM module determines both that the user interface application is authorized to play back the content and that the rights associated with the content are valid, the DRM module provides the content to a playback module for playback. In another embodiment, the DRM module is located in the host device. Other embodiments are possible, and each of the embodiments can be used alone or together in combination. Accordingly, various embodiments will now be described with reference to the attached drawings.

### BRIEF DESCRIPTION OF THE DRAWINGS

FIG. 1 is a block diagram of an exemplary host device and storage device of an embodiment.

FIG. 2 is a block diagram of a prior art operating system (OS)-level digital rights management (DRM) implementation of a content protection system.

FIG. 3 is a block diagram of a prior art content protection system with DRM functionality embedded in user interface applications.

FIG. 4 is a block diagram of a content protection system with an enhanced DRM module of an embodiment.

### DETAILED DESCRIPTION OF THE PRESENTLY PREFERRED EMBODIMENTS

### Introduction

In general, the following embodiments disclose a storage device, host device, and method for using a common digital rights management module to enforce an association between content and a user interface application. As discussed above, in some environments, a single digital rights management (DRM) module is used to support a plurality of user interface applications on a host device. In this environment, any compatible user interface application on the host device can request the DRM module to validate the DRM rights for any of the content stored on the device. So, as long as the DRM rights are valid, any user interface application on the device can play the content. In other environments, instead of having one common DRM module servicing a number of user interface applications, each user interface application would have its own embedded DRM module. However, this latter approach is more expensive (because more than one DRM license is needed) and can be less secure (because the user interface application has access to the unprotected content).

The following embodiments provide a “best of both worlds” approach, in which a single DRM module is used (to provide the cost savings), yet content can be bound to individual user interface applications. Before turning to these and other embodiments, the following section describes exemplary host and storage devices. It should be noted that these exemplary host and storage devices are merely examples and that other architectures can be used.

### Exemplary Host and Storage Devices

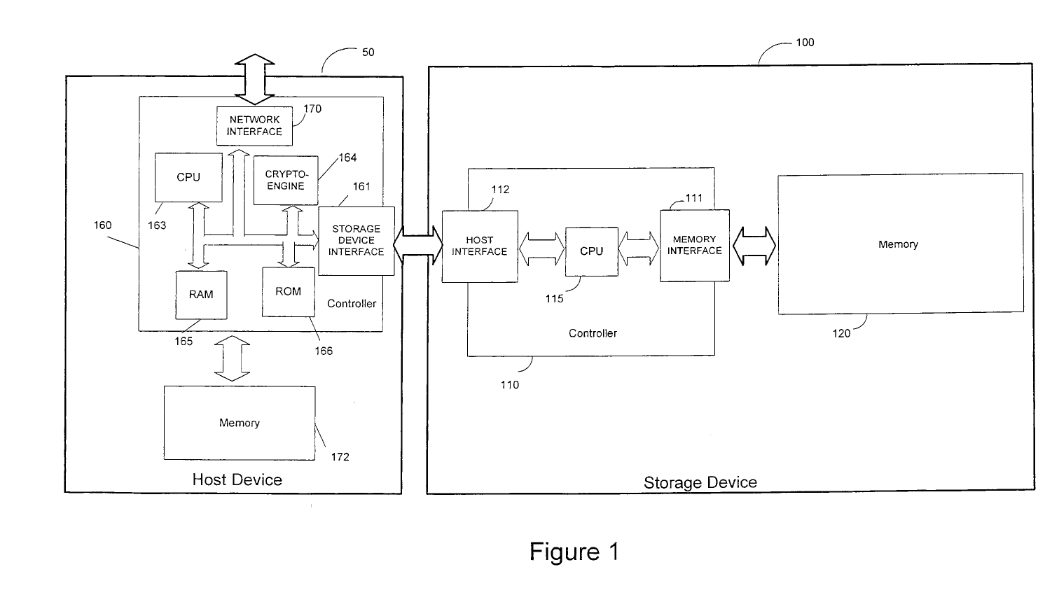

Turning now to the drawings, FIG. 1 is a block diagram of a host device 50 in communication with a storage device 100 of an embodiment. As used herein, the phrase “in communication with” could mean directly in communication with or indirectly in communication with through one or more components, which may or may not be shown or described herein. For example, the host device 50 and storage device 100 can each have mating physical connectors (interfaces) that allow the storage device 100 to be removably connected to the host device 50. The host device 50 can take any suitable form, such as, but not limited to, a mobile phone, a digital media player, a game device, a personal digital assistant (PDA), a personal computer (PC), a kiosk, a set-top box, a TV system, a book reader, or any combination thereof. In this embodiment, the storage device 100 is a mass storage device that can take any suitable form, such as, but not limited to, a handheld, removable memory card (such as a Secure Digital (SD) card or a MultiMedia Card (MMC)), a universal serial bus (USB) device, and a removable or non-removable hard drive (e.g., magnetic disk or solid-state drive). Alternatively, the storage device 100 can take the form of an embedded memory (e.g., a secure module embedded in the host device 50), such as an iNAND™ eSD/eMMC embedded flash drive by SanDisk Corporation.

As shown in FIG. 1, the storage device 100 comprises a controller 110 and a memory 120. The controller 110 comprises a memory interface 111 for interfacing with the memory 120 and a host interface 112 for interfacing with the host 50. The controller 110 also comprises a central processing unit (CPU) 115. The controller 110 can be implemented in any suitable manner. For example, the controller 110 can take the form of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example. Examples of controllers include, but are not limited to, the following microcontrollers: ARC 625D, Atmel AT91SAM, Microchip PIC18F26K20, and Silicon Labs C8051F320. The memory 120 can take any suitable form. In one embodiment, the memory 120 takes the form of a solid-state (e.g., flash) memory and can be one-time programmable, few-time programmable, or many-time programmable. However, other forms of memory, such as optical memory and magnetic memory, can be used. In one embodiment, the memory 120 comprises a public memory area that is managed by a file system on the host device 50, a private memory area that is internally managed by the controller 110, and a system memory area that is also internally managed by the controller 110. Other configurations are possible. For example, in another embodiment, the memory can contain a public memory area and a private memory area but not a system memory area, or a public memory area and system memory area but not a private memory area.

Without intending to be a limitation, the storage device 100 can be a TrustedFlash™ device from SanDisk Corporation. TrustedFlash™ technology protects the content encryption key using access control, and, as such, the content encryption key cannot be freely copied. By storing the CEK on the storage device 100, purchased content can become portable and used on a wide variety of authorized devices. A TrustedFlash™ storage device also has an accounting system, in which a user can attempt to authenticate to a playback account on the storage device, which associates specific users with various permissions and rights to stored CEKs. So, once a user has successfully authenticated to a playback account, the user can use the stored CEK, as specified by the account's permissions, to decrypt and access content that was encrypted with that CEK. The storage device 100 can also be provided with a security system that enables the revocation of a CEK when there is a compromised host device.

Turning now to the host device 50, the host device 50 comprises a controller 160 that has a storage device interface 161 for interfacing with the storage device 100 and an optional network interface 170 for interfacing with a network. The network interface 170 can use any suitable technology, such as, but not limited to, a wireless transceiver for wirelessly communicating with the network or a wired connection for a network connector, such as an Ethernet cable. The controller 160 also comprises a central processing unit (CPU) 163, a crypto-engine 164 operative to provide encryption and/or decryption operations, read access memory (RAM) 165, and read only memory (ROM) 166. The storage device 100 also contains a memory 172 for storing, for example, applications (apps) and programs (e.g., a browser, a media player, etc.) used in the operation of the host device 50. The host device 50 can contain other components (e.g., a display device, a speaker, a headphone jack, a video output connection, etc.), which are not shown in FIG. 1 to simplify the drawings. Also, other implementations of the host device 50 are possible. For example, instead of containing a hardware crypto-engine, the CPU 163 of the host device 50 may be able to perform cryptographic operations in software at a desirable speed.

In general, the host device 50 is operable to render content stored in the storage device 100. As used herein, “content” can take any suitable form, including, but not limited to, a song, a movie, a game, an application (“app”), a game installer, etc. Depending on the type of content, “render” can mean playing (e.g., when the content is a song or movie), deciphering (e.g., when the content is a game installer), or whatever action is needed to “enjoy” the content. In some embodiments, the host device 50 contains the necessary software to render the content (e.g., a media player), whereas, in other embodiments, such software is provided to the host device 50 by the memory device 100 or another entity. Also, the content file can contain not only the content itself but also metadata with a network location to an application that can render the content or other information needed to render the content.

With the exemplary host and storage devices now explained, the following sections provide a brief overview of content protection systems, followed by a detailed discussion of embodiments related to an improved content protection system using a platform DRM module.

### Brief Overview of Content Protection Systems

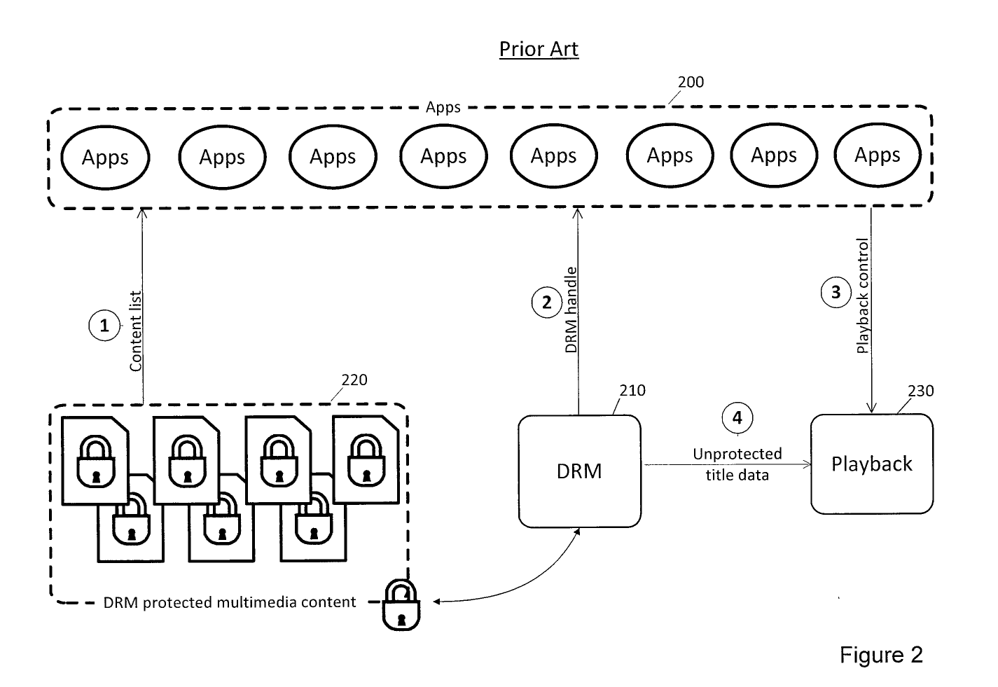

There are many mechanisms for providing content and consuming it on a host device. For example, many content services stream content to a user interface application on the host device from a server. In these services, the user interface application on the host device connects to a server on a network, and the server is responsible for controlling access to the content. Streaming services may not be ideal for mobile host devices, such as smart phones and tablets, because the continuous stream of data needed to enjoy the content can adversely affect the quality of service of other users on the network, can limit content quality depending on the available network bandwidth, and can consume a large portion of the user's limited data plan. Accordingly, for mobile host device environments, it is often desired to download or cache content locally to provide a better user experience. However, to prevent the cached or downloaded content from being copied or consumed when not authorized, such systems can use digital right management (DRM) technology to locally protect the content and manage rights, such as, but not limited to, the number of plays and when the content expires. Unfortunately, while some host device operating systems provide an application program interface (API) for private storage of content, they typically do not provide DRM functionality. Accordingly, such host devices are sometimes equipped with a DRM module that services a plurality of user interface applications running on the host device. An example of this OS-level DRM implementation is illustrated in FIG. 2.

As shown in FIG. 2, this content protection system has a plurality of user interface applications 200 serviced by a single DRM module 210, a plurality of DRM-protected multimedia content 220, and a playback module 230, which can take the form of a CODEC. As shown by arrow 1 in FIG. 2, a list of the stored content 220 is provided to the plurality of user interface applications 200, so they will know what content is available on the system. In this implementation, any of the user interface applications 200 can play any of the content 220, as long as the DRM for the content is valid, as determined by the DRM module 210. In operation, when one of the user interface applications 200 wishes to play a given piece of content, the user interface application 200 sends a request to the DRM module 210 to validate the rights for the content. If the DRM module 210 determines that the DRM rights are valid (e.g., the authorized number of plays have not been exceeded, the time period for playback is still valid, etc.), the DRM module 210 returns a DRM handle to the application 200, as shown by arrow 2. The handle identifies the piece of content whose rights have just been validated. In this implementation, the application 200 itself does not have direct access to the content 220. Instead, the DRM module 210 provides all the security. In operation, the application 200 provides playback control (e.g., play, stop, skip, etc.), along with the handle, to the playback module 230 (shown by arrow 2). In response, the playback module 230 requests the unprotected content from the DRM module 210 by providing the handle sent from the application 200 to the DRM module 210, and, after recognizing this handle, the DRM module 210 decrypts the protected content and provides it to the playback module 230 (shown by arrow 4), so the content can be played for the user. So, in this implementation the user interface application 200 is just controlling the playback experience, and the DRM module 210 handles all of the security functions. Because of this, the user interface application 200 does not need to be secure or protected.

It should be noted that the process described above occurs no matter which one of the user interface applications 200 is requesting in the content. So, playback of any of the content 220 can be requested by any of the applications 200, with the DRM module 210 validating the DRM rights of the content before playback, irrespective of which of the user interface applications is requesting the playback. However, in today's business environment, it is sometimes important for content providers to have a direct relationship with the end user and to control the user interface, as having such control can open up new revenue streams and provide additional business opportunities. As such, some content provider desire not only to have DRM rights validated before content can be played, but also that only a specified user interface application (instead of any user interface application) on the host device can playback the content. So, while the implementation shown in FIG. 2 can ensure content is consumed as intended, it cannot enforce where it gets consumed (i.e., which user interface application can consume the content).

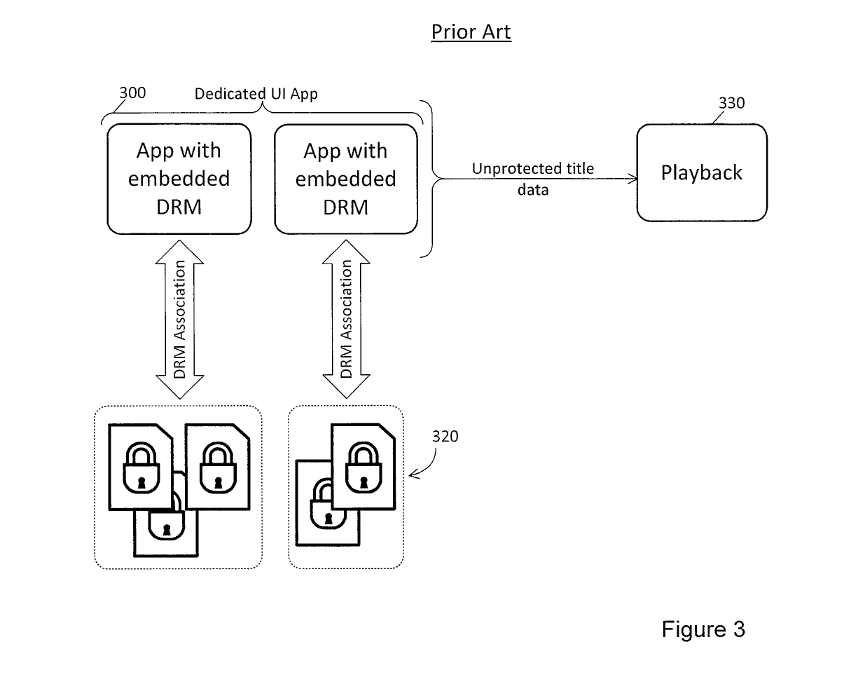

Some service providers either conscious to control the user interface and/or to provide a DRM feature that is suitable for the content providers have started to embed DRM modules in the user interface applications 300 themselves, as shown in FIG. 3. With this implementation, the rights received by an application are internally stored in the application and, thus, are out of reach of the other applications. This provides an association between a given application 300 and a given set of content 320, in contrast to the implementation shown in FIG. 2, wherein any application 200 can access any of the content 220. Also in contrast to the implementation shown in FIG. 2, the user interface application 300 here has access to decryption keys, decrypts the protected content 320, and passes the unprotected content to the playback module 330.

While the implementation shown in FIG. 3 can provide content providers with the control they desire, it can be a less secure (because the user interface application has access to clear content) and more expensive (because N number of DRM licenses would need to be paid for the N embedded DRM modules, rather than a single DRM license), as compared to the implementation shown in FIG. 2.

### Embodiments Related to Dedicated User Interface Applications with a Common DRM Module

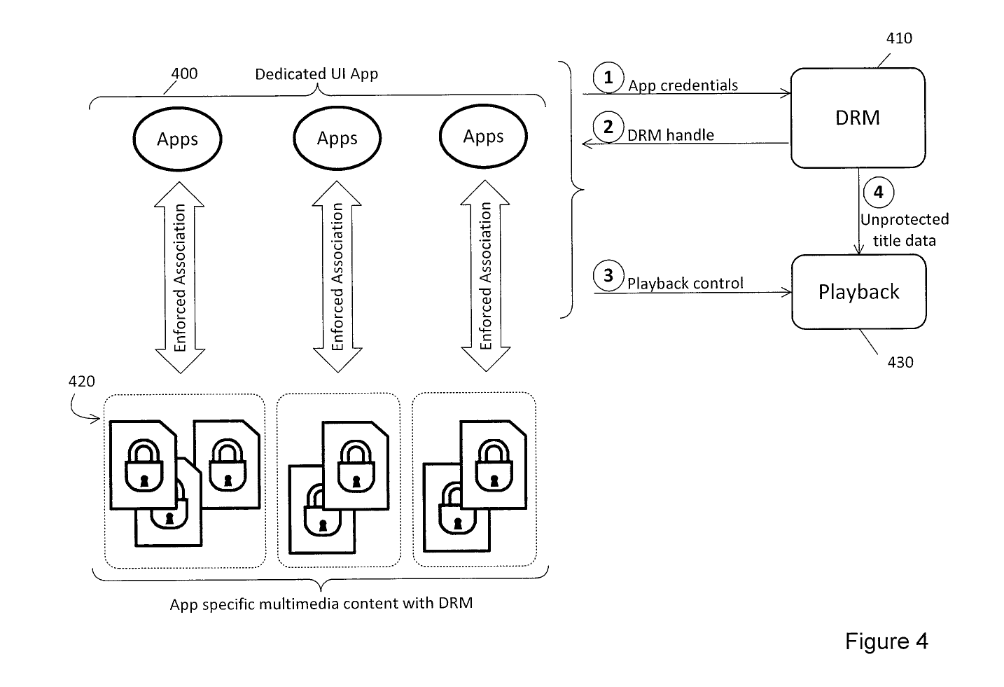

The following embodiments provide a “best of both worlds” approach, in which a single DRM module is used, yet content can be bound to individual user interface applications. As with the prior implementations, the DRM module checks to see if the DRM rights associated with the content are valid. However, the DRM module of these embodiments has an additional function not present in prior implementations. Namely, the DRM module of these embodiments is configured to determine if the user interface application requesting playback of the content is authorized to play back the content. So, even if the rights of the content are still valid, the DRM module will only provide the content to the playback module for playback if the user interface application is authorized to play back the content. This forces an associated between user interface applications and content, thus providing the tie between content and user interface applications that some service providers desire (to ensure a direct relationship with the end user and to provide the option for additional revenue streams), while still using a single DRM module (and paying only a single DRM license fee). This improved platform DRM solution will now be described in more detail in conjunction with FIG. 4.

FIG. 4 is a block diagram of a content protection system with an enhanced DRM module of an embodiment. As shown in FIG. 4, this system contains a plurality of user interface applications 400, a single DRM module 410 that supports the plurality of user interface applications 400, DRM-protected content 420, and a playback module 430. In one embodiment, the plurality of user interface applications 400 and the playback module 430 are located on the host device 50, while the DRM module 410 and/or the DRM-protected content 420 are stored on the storage device 100. Of course, other implementations are possible. For example, in another implementation, the plurality of user interface applications 400, the DRM module 410, and the playback module 430 are located on the host device 50, and the content 420 is located on the storage device 100. In yet another implementation, the plurality of user interface applications 400, the content 420, and the playback module 430 are located on the host device 50, and the DRM module 410 is located on the storage device 100. Other combinations of locations are also possible.

These components can be implemented in any suitable manner. In one embodiment, the user interface applications 400 are computer-readable program code stored in RAM 165 or ROM 166 (or another storage medium) in the host device 50 and executed by the host device's controller 160. As used herein, a “user interface application” can take the form of an “app” that is downloaded or otherwise provided to the host device 50 and, as part of its functionality, provides a user interface through which the user interacts with the app. A “user interface application” can also simply take the form of a user interface without other additional functionality. One example of a user interface application is the app downloadable from Hulu.com. Such an application can provide a mechanism for the user to choose content to be played and can provide additional functionality, such as displaying advertisements for users, accepting login and demographic information from a user, allow a user to review/provide comments about content, etc. By tying content to specific user interface applications, if a user wishes to play a specific piece of content, he could do so only through the associated user interface application.

In this embodiment, the user interface application 400 does not contain a player or a DRM module. Instead, the system contains a separate DRM module 410 and playback module 430. In this embodiment, the DRM module 410 services all of the user interface applications. While the playback module 430 is also shared by the various user interface applications 400 in this embodiment, in other embodiments, one or more of the user interface applications 400 can have their own playback module 430 for additional security. The DRM module 410 and playback module 430 can be implemented in any suitable manner. For example, the DRM module 410 can be computer-readable program code stored in RAM 165 or ROM 166 or another storage medium in the host device 50 (or in the storage device 100) and executed by the host device's controller 160 (or by the memory device's controller 110). Alternatively, the DRM module 410 can be implemented as a hardware component separate from the controller. The playback module 430, which can include a CODEC and related functionality, can be similarly implemented. Further, while the content 420 in FIG. 4 is labeled as “multimedia content,” it should be understood that the content 420 can take other forms (e.g., instead being a movie, the content 420 can be photos).

As mentioned above, the DRM module 410 in this embodiment not only checks to see if the DRM rights associated with requested content are valid but also determines if the user interface application 400 requesting playback of the content 420 is authorized to play back the content 420. In this embodiment, the DRM module 410 stores rights that specify which user interface application 400 is authorized to consume what content 420. In operation, when a user interface application 400 selects a particular piece of content 420 to be played, the selection of the content 420 triggers a request to the DRM module 410. The request includes identification of the content, as well as the user interface application's credentials (arrow 1 in FIG. 4). The credentials identify the user interface application 400 making the request. The request also preferably include the specific action being requested of the content 420 (e.g., playback), as the DRM rights associated with the content 420 can have certain restrictions depending upon the exact action being requested. In response to receiving the request, the DRM module 410 performs two steps. First, using the user interface application's credentials, it determines if the user interface application is authorized to play back the content 420. The DRM module 410 also determines if the rights associated with the content are valid (e.g., if the number of authorized plays has not been exceeded, if the time period for consuming the content has not expired, etc.).

If the DRM module 410 determines both that the user interface application 400 is authorized to play back the content 420 and that the rights associated with the content 420 are valid, the DRM module provides the content to the playback module 430. This can be done in many ways. For example, the DRM module 410 can provide the user interface application 400 with a DRM handle (arrow 2), which identifies the piece of content 420 whose rights have just been validated. In this embodiment, the user interface application 400 itself does not have direct access to the content 420, nor does it have a player. Instead, the DRM module 410 can access to the decryption keys and can decrypt the requested content using those keys, and the playback module 420 contains the player. So, in this embodiment, the user interface application 400 merely sends playback controls (e.g., play, stop, skip, etc.), along with the handle, to the playback module 430 (arrow 3). In response, the playback module 430 requests the unprotected content from the DRM module 410 by providing the handle sent from the application 400 to the DRM module 410, and, after recognizing this handle, the DRM module 410 decrypts the protected content and provides the unprotected content to the playback module 430 (shown by arrow 4), so the content can be played for the user.

There are several advantages associated with these embodiments. First, as discussed above, these embodiments provide a “best of both worlds” approach, in which a single DRM module is used, yet content can be bound to individual user interface applications. (While each piece of content 420 may be associated with only one user interface application 400, a given piece of content 420 may be accessible by several (perhaps even all) of the applications 400.) This forces an associated between user interface applications and content, thus providing the tie between content and user interface applications that some service providers desire to ensure a direct relationship with the end user and to provide the option for additional revenue streams, while still using a single DRM module (and paying only a single DRM license fee), instead of paying N licensing fees for N DRM modules embedded in N user interface applications.

Another advantage of these embodiments over the prior embedded DRM implementation pertains to security. Specifically, in the prior embedded DRM implementation, the security level of the embedded DRM module is only as good as the security level of the application in which it is embedded. However, because the platform DRM module 410 of this embodiment is shared by multiple applications 400, it can be implemented as part of the operating system of the host device 50 (or the storage device 100). As such, the security level of the DRM module 410 could be of the same level as that of the operating system, which is typically much more secure than the security level of an application. This makes it much more difficult for a hacker to hack the content 420. This may be especially true if the DRM module 420 is located on the storage device 100 (e.g., in firmware) instead of the host device 50, as the security provided on the storage device 100 can be better than the security provided in on the host device 50. However, in that situation, the unprotected content or the decryption key may need to be sent from the storage device 100 to the host device 50. Even if the unprotected content or decryption key is protected with a different protection scheme during transmission (e.g., with a session key that changes each session), there is still a risk that it can be intercepted. Accordingly, the system designer may want to consider these various trade-offs in deciding on what system architecture to use.

There are several alternatives that can be used with these embodiments. For example, in one embodiment, each of the user interface applications 400 has its own domain or account in the DRM module 410 that provide access to the keys needed to decrypt the authorized content 420. In this embodiment, a user interface application 400 would need to successfully authenticate to the account using the credentials stored in the user interface application 400 in order for the DRM module 410 to access the keys for decryption. If the user interface application 400 is able to authenticate to the DRM module 410 (and if the rights are valid), the DRM module 410 accesses the appropriate keys to decrypt the desired content 400 and provide it to the playback module 430. If a user interface application that does not have the needed credentials attempts to authenticate to the DRM module 410, the DRM module 410 will not be able to authenticate that application, and that application will not be able to access the keys needed to play the content. In that situation, the application may be offered the option to purchase rights to access the content.

In another alternative, enforcing the association between content and a user interface application can be done by restricting access to the content file, which can be performed by the operating system. For example, the operating system can restrict access to a content file to a specific user interface application by providing access rights for reading or encryption, for example. This can be done, for example, using the encrypted file system (EFS) function on Windows. Once access is restricted, then a specific user interface application can be enforced.

Alternatively, enforcing the association between content and a user interface application can be done by using a temporary file. In this alternative, the user interface application can control the content encryption key, but a temporary deciphered file is used at the time of playback and is deleted thereafter.

In yet another alternative, enforcing the association between content and a user interface application can be done by providing a dedicated rights store in the platform DRM module. In this alternative, each user interface application can have its own set of rights, and the platform DRM module can provide an application program interface (API) to allow each user interface application to create its own right store. For example, a secure handshake can be used to exchange some secret information that can be completed with some information about the user interface application. For implementations where the acquisition of rights is done by the DRM module, the API can be updated to ensure that the rights are stored in the adequate rights store. For implementations where a DRM authorized player is embedded in the user interface application, an update may be needed to ensure that the player can access the content on behalf of the authorized user interface application. This can be done, for example, through an API or parameters when embedding the player class. All the rights received by the user interface application can be stored in the dedicated store, and, thus, the user interface application can be controlled, as the backend may not deliver rights to non-authorized user interface applications.

As another alternative, enforcing the association between content and a user interface application can be done by providing rights with the dedicated user interface application. In this alternative, the backend DRM server delivers rights with information about the authorized user interface application. The platform DRM uses that information to ensure that only authorized user interface application can be used with the associated title. The authorization information can be in the form of an application ID or a shared secret, for example, and a secure handshake can be used to provide the needed information for the DRM module to validate it and grant access accordingly. Also, the authorized user interface application can control access to the content encryption key (CEK). For example, a ciphered CEK can exist for each authorized user interface application, just as, in S/Mime, each application has its own public key pair, and only an authorized application can access a CEK. In some embodiments, the backend can be pre-set to deliver rights to authorized user interface application, while, in some other embodiments, the rights acquisition protocol or API can be modified to provide information about the target user interface application. This can take the form of including the target user interface application's public certificate in the rights object acquisition protocol (ROAP) in order to receive the CEK wrapped for the user interface application. In embodiments where an authorized player is embedded in the user interface application, there can be an authorization step in which the user interface application allows unwrapping the CEK. This can be done by using the user interface application to unwrap it or by providing an API for the user interface application to authorize access to its private key for such unwrap.

In yet another embodiment, enforcing the association between content and a user interface application can be done by a parent rights object (RO). In this embodiment, the content is protected by DRM, such that the rights are associated with one or more parent rights objects under the control of an authorized user interface application. As such, only a user interface application with a valid parent RO can enable content consumption. In that embodiment, the content can be consumed by different authorized user interface application while it has its own set rights that apply for all the authorized user interface application.

In another alternate embodiment, enforcing the association between content and a user interface application can be done by controlling access to each content encryption key (CEK). In this embodiment, access to the CEK is restricted to an authorized user interface applications only. For example, the CEK can be stored in secure hardware, and access can be protected by authentication. In some embodiments, the CEKs for each user interface application are stored in a secure hardware (such as a secure storage device), and the access is protected by authentication. Access to the CEK can require the user interface application to login to the appropriate account to access the protected titles. Granted access or a successful login can result in a session ticket that is provided to the DRM module for playback. As such, the user interface application can authorize access only for a session.

In yet another alternate embodiment, the enforcing the association between content and a user interface application can be done by with access control (such as be using TrustedFlash technology). In this embodiment, the content encryption key (CEK) is stored protected in the device where the use and/or access of such CEK is controlled by an Authentication Authorization Accounting (AAA) system. Each user interface application has credentials to login and allow an integrated media server to stream the content for playback over a session URL. The accounting system allows each user interface application to have its set of keys protected by its own account.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A storage device comprising:
an interface through which the storage device can connect to and communicate with a host device, wherein the host device having a user interface application and a playback module; and
a digital rights management (DRM) module configured to:
receive, via the interface, a request from the user interface application to play back content protected by DRM;
determine if the user interface application is authorized to play back the content;
determine if rights associated with the content are valid; and
provide the content to the playback module if the DRM module determines both that the user interface application is authorized to play back the content and that the rights associated with the content are valid.

2. The storage device of claim 1, wherein the host device stores at least one additional user interface application, and wherein at least some of the at least one additional user interface application are not authorized to play back the content.

3. The storage device of claim 1, wherein the DRM module is further configured to provide the user interface application with a handle it can use to instruct the playback module to control playback of the content, if the DRM module determines that both the user interface application is authorized to play back the DRM-protected content and that the rights associated with the DRM-protected content are valid.

4. The storage device of claim 1, wherein the content is encrypted, and wherein the DRM module is further configured to decrypt to the content if the DRM module determines both that the user interface application is authorized to play back the content and that the rights associated with the content are valid, and then to provide the decrypted content to the playback module.

5. The storage device of claim 4, wherein the DRM module stores an account that controls access to a decryption key for decrypting the encrypted content, and wherein the DRM module decrypts the encrypted content only if the user interface application successfully authenticates to the account.

6. The storage device of claim 5, wherein the host device stores at least one additional user interface application, and wherein the DRM module stores at least one additional account corresponding to the at least one additional user interface application.

7. The storage device of claim 1, wherein the content is stored in the storage device.

8. The storage device of claim 1, wherein the content is stored in the host device.

9. A method for enforcing an association between content and a user interface application, the method comprising:
performing the following in a digital rights management (DRM) module in a storage device in communication with a host device having a user interface application and a playback module:
receiving a request from a user interface application in the host device to play back content protected by DRM;
determining if the user interface application is authorized to play back the content;
determining if rights associated with the content are valid; and
providing the content to the playback module if the DRM module determines both that the user interface application is authorized to play back the content and that the rights associated with the content are valid.

10. The method of claim 9, wherein the host device stores at least one additional user interface application; and wherein at least some of the at least one additional user interface application are not authorized to play back the content.

11. The method of claim 9 further comprising:
providing the user interface application with a handle it can use to instruct the playback module to control playback of the content, if the DRM module determines that both the user interface application is authorized to play back the DRM-protected content and that the rights associated with the DRM-protected content are valid.

12. The method of claim 9, wherein the content is encrypted, and wherein the method further comprises:
decrypting the content if the DRM module determines both that the user interface application is authorized to play back the content and that the rights associated with the content are valid, and then providing the decrypted content to the playback module.

13. The method of claim 12, wherein the DRM module stores an account that controls access to a decryption key for decrypting the encrypted content, and wherein the method further comprising:
decrypting the encrypted content only if the user interface application successfully authenticates to the account.

14. The method of claim 13, wherein the host device stores at least one additional user interface application, and wherein the DRM module stores at least one additional account corresponding to the at least one additional user interface application.

15. The method of claim 9, wherein the content is stored in the storage device.

16. The method of claim 9, wherein the content is stored in the host device.

17. A host device comprising:
a user interface application;
a playback module; and
a digital rights management (DRM) module configured to:
receive a request from the user interface application to play back content protected by DRM;
determine if the user interface application is authorized to play back the content;
determine if rights associated with the content are valid; and
provide the content to the playback module if the DRM module determines both that the user interface application is authorized to play back the content and that the rights associated with the content are valid.

18. The host device of claim 17, wherein the host device stores at least one additional user interface application, and wherein at least some of the at least one additional user interface application are not authorized to play back the content.

19. The host device of claim 17, wherein the DRM module is further configured to provide the user interface application with a handle it can use to instruct the playback module to control playback of the content, if the DRM module determines that both the user interface application is authorized to play back the DRM-protected content and that the rights associated with the DRM-protected content are valid.

20. The host device of claim 17, wherein the content is encrypted, and wherein the DRM module is further configured to decrypt to the content if the DRM module determines both that the user interface application is authorized to play back the content and that the rights associated with the content are valid, and then to provide the decrypted content to the playback module.

21. The host device of claim 20, wherein the DRM module stores an account that controls access to a decryption key for decrypting the encrypted content, and wherein the DRM module decrypts the encrypted content only if the user interface application successfully authenticates to the account.

22. The host device of claim 21 further comprising at least one additional user interface application, and wherein the DRM module stores at least one additional account corresponding to the at least one additional user interface application.

23. The host device of claim 17, wherein the content is stored in the host device.

24. The host device of claim 17, wherein the content is stored in a storage device in communication with the host device.

25. A method for enforcing an association between content and a user interface application, the method comprising:
performing the following in a digital rights management (DRM) module in a host device storing having a user interface application and a playback module:
receiving a request from a user interface application to play back content protected by DRM;
determining if the user interface application is authorized to play back the content;
determining if rights associated with the content are valid; and
providing the content to the playback module if the DRM module determines both that the user interface application is authorized to play back the content and that the rights associated with the content are valid.

26. The method of claim 25, wherein the host device stores at least one additional user interface application; and wherein at least some of the at least one additional user interface application are not authorized to play back the content.

27. The method of claim 25 further comprising:
providing the user interface application with a handle it can use to instruct the playback module to control playback of the content, if the DRM module determines that both the user interface application is authorized to play back the DRM-protected content and that the rights associated with the DRM-protected content are valid.

28. The method of claim 25, wherein the content is encrypted, and wherein the method further comprises:
decrypting the content if the DRM module determines both that the user interface application is authorized to play back the content and that the rights associated with the content are valid, and then providing the decrypted content to the playback module.

29. The method of claim 28, wherein the DRM module stores an account that controls access to a decryption key for decrypting the encrypted content, and wherein the method further comprising:
decrypting the encrypted content only if the user interface application successfully authenticates to the account.

30. The method of claim 29, wherein the host device stores at least one additional user interface application, and wherein the DRM module stores at least one additional account corresponding to the at least one additional user interface application.

31. The method of claim 25, wherein the content is stored in the host device.

32. The method of claim 25, wherein the content is stored in a storage device in communication with the host device.
